(19) United States
(12) Patent Application Publication
(10) Pub. No.: US 2025/0344698 A1
(43) Pub. Date: Nov. 13, 2025

(54) A METHOD OF CONTROLLING WEEDS

(71) Applicant: SYNGENTA CROP PROTECTION AG, Basel (CH)

(72) Inventors: Joe DOWNES, Bracknell, Berkshire (GB); Lucy JACKSON, Bracknell, Berkshire (GB)

(73) Assignee: SYNGENTA CROP PROTECTION AG, Basel (CH)

(21) Appl. No.: 18/867,400

(22) PCT Filed: May 17, 2023
(86) PCT No.: PCT/EP2023/063271

§ 371 Date: Nov. 19, 2024

(30) Foreign Application Priority Data
May 20, 2022 (EP) 22174679.5

(51) Int. Cl. A01N 43/80; A01P 13/02

(52) U.S. Cl. CPC A01N 43/80; A01P 13/02

(57) ABSTRACT

The present invention relates to a method for controlling the growth of protoporphyrinogen IX oxidase (PPO) inhibitor herbicide resistant weeds, which comprises applying to the weed, part of the weed, weed propagation material, or the locus of the weed, an effective amount of a compound of Formula (I), wherein the substituents are as defined in claim 1, and wherein the PPO-resistant weeds are weeds that are resistant to at least one PPO-inhibiting herbicide, except the compounds of Formula (I).

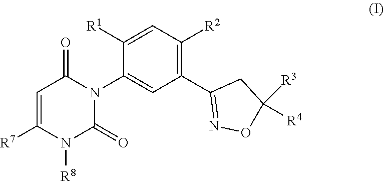

The present invention relates to a method for controlling the growth of protoporphrinogen IX oxidase (PPO) inhibitor herbicide resistant weeds, which comprises applying to the weed, part of the weed, weed propagation material, or the locus of the weed, an effective amount of a compound of Formula (I), and wherein the PPO resistant weeds are weeds that are resistant to at least one PPO-inhibiting herbicide, except the compounds of Formula (I).

Wang et. al. in Journal of Agricultural and Food Chemistry 2019 67 (45), 12382-12392, discloses various N-isoxazolinylphenyltriazinones as promising protoporphyrinogen IX oxidase (PPO) inhibitors for use as herbicidal compounds. These and similar compounds have been disclosed in WO2016/095768 and WO2020/063613.

Herbicide resistance has been known since the 1950s. Herbicide resistant weeds, for example PPO inhibitor herbicide resistant weeds, such as Acalypha spp., Amaranthus spp., Ambrosia spp., Avena spp., Conyza spp., Descurainia spp., Euphorbia spp., and Senecio spp. presents a serious problem for efficient weed control because such resistant weeds are increasingly widespread and where resistant weeds are present, the application of affected herbicides is much less effective than would normally be expected. In particular, PPO inhibitor herbicide resistant weeds like Amaranthus palmeri and Amaranthus tuberculatus are a huge problem for farmers in many parts of the world. Furthermore, the proportion of herbicide resistant individuals is rising over time due to selection pressure in situations where one herbicide mode of action (MOA) group is applied repeatedly.

The primary mechanism of action of PPO-inhibitor herbicides is inhibition of the protoporphyrinogen oxidase (PPO), which is an enzyme in the chloroplast cell that oxidizes protoporphyrinogen IX (PPGIX) to produce protoporphyrin IX (PPIX). PPIX is important because it is a precursor molecule for both chlorophyll (needed for photosynthesis) and heme (needed for electron transfer chains). Inhibitors of the PPO enzyme, however, do more than merely block the production of chlorophyll and heme. The inhibition of PPO by PPO-inhibitors leads to the build-up of protoporphrinogen IX which leaks into the cytosol. Acting as a photosensitiser, protoporphyrinogen IX's presence in the cytosol leads to the formation of reactive oxygen species which attack and destroy lipids membranes leading to cell death.

Many of the same mechanisms of resistance to PPO-inhibitor herbicides have been found in different weed species, including amino acid substitutions R128M/G (also referred as R98), as well as a codon (glycine) deletion at the position 210 (A210) in PPX2 gene coding for the target enzyme of PPO-inhibitor herbicides, i.e. PPO.

In crop protection it is desirable to increase the specificity and reliability of the action of active compounds, in particular, it is desirable for the crop protection product to simultaneously control the harmful weeds effectively and be tolerated by useful plants.

Thus, there is a need for a novel method to effectively control herbicide resistant weeds, in particular PPO inhibitor herbicide resistant weeds, which at the same time is tolerated by useful plants and crops in the same field.

Surprisingly, it has been found that compounds of Formula (I) provide efficient control of PPO resistant weeds.

According to a first aspect of the invention, there is provided a method for controlling the growth of protoporphyrinogen IX oxidase (PPO) inhibitor herbicide resistant weeds, which comprises applying to the weed, part of the weed, weed propagation material, or the locus of the weed, an effective amount of a compound of Formula (I)

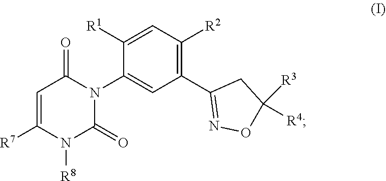

wherein
each R¹ and R² is selected from the group consisting of hydrogen and halogen; R³ is selected from the group consisting of hydrogen, C₁-C₄alkyl, CO₂R⁵ and CH₂OR⁶;
R⁴ is selected from the group consisting of hydrogen and C₁-C₄alkyl;
R⁵ is selected from the group consisting of hydrogen, C₁-C₄alkyl, C₁-C₄haloalkyl, C₃-C₆alkenyl, C₃-C₆alkynyl, C₁-C₄alkoxyC₁-C₄alkyl, C₁₋₄CalkylcarbonylC₁₋₄Calkyl and heterocyclylC₁-C₃alkyl;
R⁶ is selected from the group consisting of C₁-C₂alkylsulfonyl, C₁-C₄alkylcarbonyl and C₃-C₄cycloalkylcarbonyl;
R⁷ is selected from the group consisting of hydrogen, C₁-C₄alkyl and C₁-C₄haloaklyl;
R⁸ is selected from the group consisting of hydrogen, amino, C₁-C₆alkyl, C₃-C₆alkenyl and C₃-C₆alkynyl; and
   wherein the PPO-resistant weeds are weeds that are resistant to at least one PPO-inhibiting herbicide, except the compounds of Formula (I). According to a second aspect of the invention, there is provided an agrochemical composition comprising a herbicidally effective amount of a compound of Formula (I) and an agrochemically-acceptable diluent or carrier. Such an agricultural composition may further comprise at least one additional active ingredient. In one embodiment, the additional active ingredient. Preferably, the additional active ingredient is S-metolachlor, glufosinate, L-glufosinate, glyphosate, mesotrione, bicyclopyrone, or metribuzin.

According to a third aspect of the invention, there is provided a method of controlling or preventing undesirable plant growth of weeds with a mutation at amino acid 128, amino acid 210, or amino acid 399 in the gene coding for the protoporphyrinogen oxidase enzyme, wherein a herbicidally effective amount of a compound of Formula (I), or a composition comprising this compound as active ingredient, is applied to the weed, part of the weed, weed propagation material, or the locus of the weed. Preferably, there is provided a method of controlling or preventing undesirable plant growth of weeds with a mutation at amino acid 128 and/or amino acid 210, in the gene coding for the protoporphyrinogen oxidase enzyme, wherein a herbicidally effective amount of a compound of Formula (I), or a composition comprising this compound as active ingredient, is applied to the weed, part of the weed, weed propagation material, or the locus of the weed.

According to a fourth aspect of the invention, there is provided the use of a compound of Formula (I) for controlling the growth of protoporphyrinogen IX oxidase (PPO) inhibitor herbicide resistant weeds. In particular, there is provided the use of a compound of Formula (I) for controlling the growth of protoporphyrinogen IX oxidase (PPO) inhibitor herbicide resistant weeds, wherein the protoporphyrinogen IX oxidase (PPO) inhibitor herbicide resistant weeds have a mutation at amino acid 128, amino acid 210, and/or amino acid 399 in the gene coding for the protoporphyrinogen oxidase enzyme. Preferably, there is provided the use of a compound of Formula (I) for controlling the growth of protoporphyrinogen IX oxidase (PPO) inhibitor herbicide resistant weeds, wherein the protoporphyrinogen IX oxidase (PPO) inhibitor herbicide resistant weeds have a mutation at amino acid 128 and/or amino acid 210 in the gene coding for the protoporphyrinogen oxidase enzyme.

According to a fifth aspect of the invention, there is provided the use of an agrochemical composition comprising a compound of Formula (I) for controlling the growth of protoporphyrinogen IX oxidase (PPO) inhibitor herbicide resistant weeds. In particular, there is provided the use of a composition comprising a compound of Formula (I) for controlling the growth of protoporphyrinogen IX oxidase (PPO) inhibitor herbicide resistant weeds, wherein the protoporphyrinogen IX oxidase (PPO) inhibitor herbicide resistant weeds have a mutation at amino acid 128, amino acid 210 and/or amino acid 399 in the gene coding for the protoporphyrinogen oxidase enzyme. Preferably, there is provided the use of a composition comprising a compound of Formula (I) for controlling the growth of protoporphyrinogen IX oxidase (PPO) inhibitor herbicide resistant weeds, wherein the protoporphyrinogen IX oxidase (PPO) inhibitor herbicide resistant weeds have a mutation at amino acid 128 and/or amino acid 210 in the gene coding for the protoporphyrinogen oxidase enzyme.

The presence of one or more possible asymmetric carbon atoms in a compound of Formula (I) means that the compounds may occur in chiral isomeric forms, i.e., enantiomeric or diastereomeric forms. Also, atropisomers may occur as a result of restricted rotation about a single bond. Formula (I) is intended to include all those possible isomeric forms and mixtures thereof. The present invention includes all those possible isomeric forms and mixtures thereof for a compound of Formula (I). Likewise, Formula (I) is intended to include all possible tautomers (including lactam-lactim tautomerism and keto-enol tautomerism) where present. The present invention includes all possible tautomeric forms for a compound of Formula (I). Similarly, where there are di-substituted alkenes, these may be present in E or Z form or as mixtures of both in any proportion. The present invention includes all these possible isomeric forms and mixtures thereof for a compound of Formula (I).

The compounds of Formula (I) will typically be provided in the form of an agronomically acceptable salt, a zwitterion or an agronomically acceptable salt of a zwitterion. This invention covers all such agronomically acceptable salts, zwitterions and mixtures thereof in all proportions.

As used herein, the term “halogen” refers to fluorine (fluoro), chlorine (chloro), bromine (bromo) or iodine (iodo).

As used herein, amino means an —NH₂ group.

As used herein, the term “C₁-C₆alkyl” refers to a straight or branched hydrocarbon chain radical consisting solely of carbon and hydrogen atoms, containing no unsaturation, having from one to six carbon atoms, and which is attached to the rest of the molecule by a single bond. The term “C₁-C₄alkyl” is to be construed accordingly. Examples of C₁-C₆alkyl include, but are not limited to, methyl, ethyl, n-propyl, n-butyl, n-pentyl, n-hexyl and the isomers thereof, for example, iso-propyl, iso-butyl, sec-butyl, tert-butyl or iso-amyl.

As used herein, the term “C₂-C₆alkenyl” refers to a straight or branched hydrocarbon chain radical group consisting solely of carbon and hydrogen atoms, containing at least one double bond that may be of either the (E) or (Z)configuration, having from two to six carbon atoms, which is attached to the rest of the molecule by a single bond. C₃-C₆alkenyl is to be construed accordingly. Examples of C₂-C₆alkenyl include, but are not limited to, prop-1-enyl, allyl (prop-2-enyl), and but-1-enyl.

As used herein, the term “C₂-C₆alkynyl” refers to a straight or branched hydrocarbon chain radical group consisting solely of carbon and hydrogen atoms, containing at least one triple bond, having from two to six carbon atoms, and which is attached to the rest of the molecule by a single bond. The term “C₃-C₆alkynyl” is to be construed accordingly. Examples of C₂-C₆alkynyl include, but are not limited to, prop-1-ynyl, propargyl (prop-2-ynyl), and but-1-ynyl.

As used herein, the term “C₁-C₆haloalkyl” refers to a C₁-C₆alkyl radical as generally defined above substituted by one or more of the same or different halogen atoms. C₁-C₄haloalkyl is to be construed accordingly. Examples of C₁-C₆haloalkyl include, but are not limited to fluoromethyl, fluoroethyl, difluoromethyl, trifluoromethyl, and 2,2,2-trifluoroethyl.

As used herein, the term “C₁-C₄alkoxyC₁-C₄alkyl” refers to a radical of the formula R_{b}—O—Rₐ— wherein R_{b} is a C₁-C₄alkyl radical as generally defined above, and Rₐ is a C₁₋₄alkylene radical as generally defined above.

As used herein, the term “C₁-C₄alkylcarbonylC₁-C₄alkyl” refers to a radical of the formula —R_{b}C(O)Rₐ wherein Rₐ is a C₁-C₄alkyl as generally defined above and R_{b} is a C₁₋₄alkylene radical as generally defined above. As used herein, the term “heterocyclyl” or “heterocyclic” refers to a stable 5- or 6-membered non-aromatic monocyclic ring radical which comprises 1, 2, or 3 heteroatoms individually selected from nitrogen, oxygen and sulfur. The heterocyclyl radical may be bonded to the rest of the molecule via a carbon atom or heteroatom. Examples of heterocyclyl include, but are not limited to, pyrrolinyl, pyrrolidyl, tetrahydrofuranyl, tetrahydrothienyl, tetrahydrothiopyranyl, piperidyl, piperazinyl, tetrahydropyranyl, dioxolanyl, morpholinyl, oxazinanyl, oxetanyl, or δ-lactamyl.

As used herein, the term “heterocyclylC₁-C₂alkyl” refers to a heterocyclic ring as defined above which is attached to the rest of the molecule by a C₁-C₂alkylene radical.

As used herein, the term “C₁₋₆alkylsulfonyl” refers to a radical of the formula —S(O)₂Rₐ wherein Rₐ is a C₁₋₆alkyl radical as generally defined above. The term “C₁₋₂alkylsulfonyl” is to be construed accordingly.

As used herein, the term “C₁-C₄alkylcarbonyl” refers to a radical of the formula RₐC(O)—, wherein Rₐ is a C₁-C₄alkyl radical as generally defined above.

As used herein, the term “C₃-C₈cycloalkyl” refers to a stable, monocyclic ring radical which is saturated and contains 3 to 8 carbon atoms. Examples of C₃-C₈cycloalkyl include, but are not limited to, cyclopropyl, cyclobutyl, cyclopentyl and cyclohexyl.

As used herein, the term “C₃-C₈cycloalkylcarbonyl” refers to a radical of the formula RₐC(O)—, wherein Rₐ is a C₃-C₈cycloalkyl radical as defined above. C₅-C₄cycloalkylcarbonyl is to be construed accordingly.

As used herein, the terms “PPO inhibitor herbicide resistant weed”, “PPO-inhibiting herbicide resistant weed”, “PPO inhibitor resistant weed”, “PPO resistant weed”, “protoporphyrinogen IX oxidase inhibitor herbicide resistant weed”, “protoporphyrinogen IX oxidase inhibiting herbicide resistant weed”, “protoporphyrinogen oxidase inhibitor herbicide resistant weed”, and “protoporphyrinogen oxidase inhibiting herbicide resistant weed” are synonyms and refer to a plant that, in relation to a treatment with an appropriate or over-appropriate rate of PPO inhibiting herbicide application, has inherited, developed or acquired an ability to
(1) survive that treatment if it is one that eradicates the wild-type weed; or
(2) exhibits significant vegetative growth or thrive after that treatment, if it is one that suppresses growth of the wild-type weed.

PPO resistant weeds are weeds which are not controlled by the application of known PPO inhibitor herbicides except for the compounds of Formula (I), whereas the sensitive biotype is controlled at that use rate.

Suitable agronomically acceptable salts of the present invention can be with cations that include but are not limited to, metals, conjugate acids of amines and organic cations. Examples of suitable metals include aluminium, calcium, cesium, copper, lithium, magnesium, manganese, potassium, sodium, iron and zinc.

Examples of suitable amines include allylamine, ammonia, amylamine, arginine, benethamine, benzathine, butenyl-2-amine, butylamine, butylethanolamine, cyclohexylamine, decylamine, diamylamine, dibutylamine, diethanolamine, diethylamine, diethylenetriamine, diheptylamine, dihexylamine, diisoamylamine, diisopropylamine, dimethylamine, dioctylamine, dipropanolamine, dipropargylamine, dipropylamine, dodecylamine, ethanolamine, ethylamine, ethylbutylamine, ethylenediamine, ethylheptylamine, ethyloctylamine, ethylpropanolamine, heptadecylamine, heptylamine, hexadecylamine, hexenyl-2-amine, hexylamine, hexylheptylamine, hexyloctylamine, histidine, indoline, isoamylamine, isobutanolamine, isobutylamine, isopropanolamine, isopropylamine, lysine, meglumine, methoxyethylamine, methylamine, methylbutylamine, methylethylamine, methylhexylamine, methylisopropylamine, methylnonylamine, methyloctadecylamine, methylpentadecylamine, morpholine, N,N-diethylethanolamine, N-methylpiperazine, nonylamine, octadecylamine, octylamine, oleylamine, pentadecylamine, pentenyl-2-amine, phenoxyethylamine, picoline, piperazine, piperidine, propanolamine, propylamine, propylenediamine, pyridine, pyrrolidine, sec-butylamine, stearylamine, tallowamine, tetradecylamine, tributylamine, tridecylamine, trimethylamine, triheptylamine, trihexylamine, triisobutylamine, triisodecylamine, triisopropylamine, trimethylamine, tripentylamine, tripropylamine, tris(hydroxymethyl)aminomethane, and undecylamine. Examples of suitable organic cations include benzyltributylammonium, benzyltrimethylammonium, benzyltriphenylphosphonium, choline, tetrabutylammonium, tetrabutylphosphonium, tetraethylammonium, tetraethylphosphonium, tetramethylammonium, tetramethylphosphonium, tetrapropylammonium, tetrapropylphosphonium, tributylsulfonium, tributylsulfoxonium, triethylsulfonium, triethylsulfoxonium, trimethylsulfonium, trimethylsulfoxonium, tripropylsulfonium and tripropylsulfoxonium.

Suitable agronomically acceptable salts of the present invention can be with cations that include but are not limited to, metals, conjugate acids of amines and organic cations. Examples of suitable metals include aluminium, calcium, cesium, copper, lithium, magnesium, manganese, potassium, sodium, iron and zinc. Examples of suitable amines include allylamine, ammonia, amylamine, arginine, benethamine, benzathine, butenyl-2-amine, butylamine, butylethanolamine, cyclohexylamine, decylamine, diamylamine, dibutylamine, diethanolamine, diethylamine, diethylenetriamine, diheptylamine, dihexylamine, diisoamylamine, diisopropylamine, dimethylamine, dioctylamine, dipropanolamine, dipropargylamine, dipropylamine, dodecylamine, ethanolamine, ethylamine, ethylbutylamine, ethylenediamine, ethylheptylamine, ethyloctylamine, ethylpropanolamine, heptadecylamine, heptylamine, hexadecylamine, hexenyl-2-amine, hexylamine, hexylheptylamine, hexyloctylamine, histidine, indoline, isoamylamine, isobutanolamine, isobutylamine, isopropanolamine, isopropylamine, lysine, meglumine, methoxyethylamine, methylamine, methylbutylamine, methylethylamine, methylhexylamine, methylisopropylamine, methylnonylamine, methyloctadecylamine, methylpentadecylamine, morpholine, N,N-diethylethanolamine, N-methylpiperazine, nonylamine, octadecylamine, octylamine, oleylamine, pentadecylamine, pentenyl-2-amine, phenoxyethylamine, picoline, piperazine, piperidine, propanolamine, propylamine, propylenediamine, pyridine, pyrrolidine, sec-butylamine, stearylamine, tallowamine, tetradecylamine, tributylamine, tridecylamine, trimethylamine, triheptylamine, trihexylamine, triisobutylamine, triisodecylamine, triisopropylamine, trimethylamine, tripentylamine, tripropylamine, tris(hydroxymethyl)aminomethane, and undecylamine. Examples of suitable organic cations include benzyltributylammonium, benzyltrimethylammonium, benzyltriphenylphosphonium, choline, tetrabutylammonium, tetrabutylphosphonium, tetraethylammonium, tetraethylphosphonium, tetramethylammonium, tetramethylphosphonium, tetrapropylammonium, tetrapropylphosphonium, tributylsulfonium, tributylsulfoxonium, triethylsulfonium, triethylsulfoxonium, trimethylsulfonium, trimethylsulfoxonium, tripropylsulfonium and tripropylsulfoxonium.

The following list provides definitions, including preferred definitions, for substituents R¹, R², R³, R⁴, R⁵, R⁶, R⁷ and R⁸ with reference to the compounds of Formula (I) according to the invention. For any one of these substituents, any of the definitions given below may be combined with any definition of any other substituent given below or elsewhere in this document.

R¹ is selected from the group consisting of hydrogen and halogen. Preferably, R¹ is selected from the group consisting of hydrogen, chlorine and fluorine. More preferably, R¹ is selected from the group consisting of chlorine and fluorine.

R² is selected from the group consisting of hydrogen and halogen. Preferably, R² is selected from the group consisting of chlorine and bromine.

R³ is selected from the group consisting of hydrogen, C₁-C₄alkyl, C₀₂R⁵ and CH₂OR₆. Preferably, R³ is selected from the group consisting of CO₂R⁵ and CH₂OR⁶. More preferably, R³ is CO₂R⁵.

R⁴ is selected from the group consisting of hydrogen and C₁-C₄alkyl. More preferably, R⁴ is selected from the group consisting of hydrogen and C₁-C₂alkyl.

R⁵ is selected from the group consisting of hydrogen, C₁-C₄alkyl, C₁-C₄haloalkyl, C₃-C₆alkenyl, C₃-C₆alkynyl, C₁-C₄alkoxyC₁-C₄alkyl, C₁-C₄alkylcarbonylC₁-C₄alkyl and heterocyclylC₁-C₃alkyl. Preferably, R⁵ is selected from the group consisting of H, CH₃, C₂H₅, CH₃CH₂CH₂, CH₃CH₂CH₂CH₂, (CH₃)₂CH, (CH₃)₂CHCH₂, (CH₃)₃C, CF₃CH₂, allyl, propargyl, CH₃OCH₂CH₂, C₂H₅OCH₂CH₂, CH₃CO₂CH₂CH₂ and tetrahydrofuranmethyl. More preferably, R⁵ is selected from the group consisting of hydrogen, and C₁-C₄alkyl.

R⁶ is selected from the group consisting of C₁-C₂alkylsulfonyl, C₁-C₄alkylcarbonyl and C₃-C₄cycloalkylcarbonyl. Preferably, R⁶ is selected from the group consisting of C₁-C₂alkylsulfonyl, C₁-C₄alkylcarbonyl and cyclopropylcarbonyl.

R⁷ is selected from the group consisting of hydrogen, C₁-C₄alkyl and C₁-C₄haloaklyl. Preferably. R⁷ is selected from the group consisting of C₁-C₄haloalkyl. More preferably, R⁷ is CF₃.

R⁸ is selected from the group consisting of hydrogen, amino, C₁-C₆alkyl, C₃-C₆alkenyl and C₃-C₆alkynyl. Preferably, R⁸ is C₁-C₄alkyl. More preferably, R⁸ is CH₃.

A preferred subset of compounds is one in which: R¹ is selected from the group consisting of hydrogen, chlorine and fluorine; R² is selected from the group consisting of chlorine and bromine; R³ is selected from the group consisting of CO₂R⁵ and CH₂OR⁶; R⁴ is selected from the group consisting of H, CH₃ and C₂H₅; R⁵ is selected from the group consisting of H, CH₃, C₂H₅, CH₃CH₂CH₂, CH₃CH₂CH₂CH₂, (CH₃)₂CH, (CH₃)₂CHCH₂, (CH₃)₃C, CF₃CH₂, allyl, propargyl, CH₃OCH₂CH₂, C₂H₅OCH₂CH₂, CH₃CO₂CH₂CH₂ and tetrahydrofuranmethyl; R⁶ is selected from the group consisting of C₁-C₄alkylcarbonyl, cyclopropylcarbonyl, and C₁-C₂alkylsulfonyl; R⁷ is CF₃; and R⁸ is CH₃.

A more preferred subset of compounds is one in which: R¹ is selected from the group consisting of hydrogen, chlorine and fluorine; R² is selected from the group consisting of chlorine and bromine; R³ is CO₂R⁵; R⁴ is selected from the group consisting of H, CH₃ and C₂H₅; R⁵ is selected from the group consisting of H, CH₃, C₂H₅, CH₃CH₂CH₂, CH₃CH₂CH₂CH₂, (CH₃)₂CH, (CH₃)₂CHCH₂, and (CH₃)₃C; R⁷ is CF₃; and R⁸ is CH₃.

A still more preferred subset of compounds is one in which: R¹ is selected from of hydrogen, chlorine and fluorine; R² is selected from chlorine and bromine; R³ is CO₂R⁵; R⁴ is methyl; R⁷ is trifluoromethyl; and R⁸ is methyl. Two particularly preferred compounds are those wherein R¹ is selected from chlorine and fluorine; R² is chlorine; R³ is CO₂R⁵; R⁴ is methyl; R⁷ is trifluoromethyl; and R⁸ is methyl.

Most preferably, the compound of Formula (I) is 3-(2-chloro-4-fluoro-5-(3-methyl-2,6-dioxo-4-trifluoromethyl-3,6-dihydropyrimidin-1(2H)-yl)phenyl)-5-methyl-4,5-dihydroisoxazole-5-carboxylic acid ethyl ester (also referred to herein as ‘Compound 8’).

Table of Examples
This table discloses specific compounds of Formula (I),
wherein and R⁷ is trifluoromethyl and R⁸ is methyl.

| Cpd No. | R¹ | R² | R³ | R⁴ |
|---|---|---|---|---|
| 1 | H | Cl | CO₂H | Me |
| 2 | H | Cl | CO₂Me | Me |
| 3 | H | Cl | CO₂Et | Me |
| 4 | H | Cl | CH₂OCOMe | Me |
| 5 | H | Cl | CH₂OSO₂Me | Me |
| 6 | F | Cl | CO₂H | Me |
| 7 | F | Cl | CO₂Me | Me |
| 8 | F | Cl | CO₂Et | Me |
| 9 | F | Cl | CH₂OCOMe | Me |
| 10 | F | Cl | CH₂OSO₂Me | Me |
| 11 | Cl | Cl | CO₂H | Me |
| 12 | Cl | Cl | CO₂Me | Me |
| 13 | Cl | Cl | CO₂Et | Me |
| 14 | Cl | Cl | CH₂OCOMe | Me |
| 15 | Cl | Cl | CH₂OSO₂Me | Me |
| 16 | H | Br | CO₂H | Me |
| 17 | H | Br | CO₂Me | Me |
| 18 | H | Br | CO₂Et | Me |
| 19 | H | Br | CH₂OCOMe | Me |
| 20 | H | Br | CH₂OSO₂Me | Me |
| 21 | F | Br | CO₂H | Me |
| 22 | F | Br | CO₂Me | Me |
| 23 | F | Br | CO₂Et | Me |
| 24 | F | Br | CH₂OCOMe | Me |
| 25 | F | Br | CH₂OSO₂Me | Me |
| 26 | Cl | Br | CO₂H | Me |
| 27 | Cl | Br | CO₂Me | Me |
| 28 | Cl | Br | CO₂Et | Me |
| 29 | Cl | Br | CH₂OCOMe | Me |
| 30 | Cl | Br | CH₂OSO₂Me | Me |
| 31 | H | Cl | CO₂H | H |
| 32 | H | Cl | CO₂Me | H |
| 33 | H | Cl | CO₂Et | H |
| 34 | H | Cl | CH₂OCOMe | H |
| 35 | H | Cl | CH₂OSO₂Me | H |
| 36 | F | Cl | CO₂H | H |
| 37 | F | Cl | CO₂Me | H |
| 38 | F | Cl | CO₂Et | H |
| 39 | F | Cl | CH₂OCOMe | H |
| 40 | F | Cl | CH₂OSO₂Me | H |
| 41 | Cl | Cl | CO₂H | H |
| 42 | Cl | Cl | CO₂Me | H |
| 43 | Cl | Cl | CO₂Et | H |
| 44 | Cl | Cl | CH₂OCOMe | H |
| 45 | Cl | Cl | CH₂OSO₂Me | H |

A list of weeds which are resistant to inhibition of protoporphrinogen oxidase may be found (organized by mode of action), at: https://www.weedscience.org/summary/MOA.asDx. Preferred PPO resistant weeds are those selected from the group comprising Acalypha spp., Amaranthus spp., Ambrosia spp., Avena spp., Conyza spp., Descurainia spp., Eleusine spp., Euphorbia spp., Lolium spp., Poa spp., and Senecio spp.

Examples of weeds resistant to inhibition of protoporphyrinogen oxidase include, but are not limited to Acalypha australis (Asian Copperleaf), Amaranthus hybridus (syn: quitensis) (Smooth Pigweed), Amaranthus palmeri (Palmer Amaranth), Amaranthus retroflexus (Redroot Pigweed), Amaranthus tuberculatus (Amaranthus rudis) (Tall/Common Waterhemp), Ambrosia artemisiifolia (Common Ragweed), Avena fatua (Wild Oat), Conyza sumatrensis (Sumatran Fleabane), Descurainia sophia (Flixweed), Eleusine indica (Goosegrass), Euphorbia heterophylla (Wild Poinsettia), Lolium rigidum (Rigid Ryegrass), Poa annua (Annual Bluegrass), and Senecio vernalis (Eastern Groundsel).

Preferably, the weeds are resistant to inhibition of protoporphyrinogen oxidase are from the Amaranthus spp. genus. More preferably, the weeds are resistant to inhibition of protoporphyrinogen oxidase are Amaranthus palmeri and/or Amaranthus tuberculatus.

Amaranthus palmeri is a species of edible flowering plant in the amaranth genus. It has several common names, including Palmer amaranth, carelessweed, dioecious amaranth, Palmer's amaranth, and Palmer's pigweed. Control of Amaranthus palmeri is becoming more and more difficult for farmers, due to its ability to proliferate traits and thus quickly develop resistance to herbicides. As a result, Amaranthus palmeri was described as the ‘king of weeds’ in Chemical & Engineering News in 2019, see volume 97, issue 31.

Amaranthus tuberculatus or Amaranthus tamariscinus, commonly known as roughfruit amaranth, rough-fruited water-hemp, tall waterhemp, common waterhemp, or Redroot pigweed, is a species of flowering plant. It is a summer annual broadleaf with a germination period that lasts several months. Tall waterhemp has been reported as a weed in 40 of 50 U.S. states as of 2007.

The resistance mechanism of the PPO inhibitor resistant weeds to be controlled in the present invention may be point-of-action resistance due to point of action mutation or non-working-point resistance independent of the point of action mutation. Acting point mutations include Arg128Leu of PPO, Arg128Met, Arg128Gly, Arg128His, Arg128Ala, Arg128Cys, Arg128Glu, Arg12811e, Arg128Lys, Arg128Asn, Arg128Gln, Arg128Ser, Arg128Thr, Arg128Val, Arg128Tyr, Gly210 deficiency, Ala210 defect, Gly210Thr, Ala210Thr, G211 deficiency, Gly114Glu, Ser149IIe, and Gly399Ala (amino acid number all are standardized in the sequence of PPO2 of Amaranthus palmeri).

Although PPO1 and PPO2 are present in the PPO of weeds, the mutation may be either PPO1 or PPO2, or both. The present invention is suitable as a method of controlling PPO inhibitor resistant weeds having mutations in PPO2.

For example, the Arg128Met mutation means that there is a mutation in the 128th amino acid. The following are examples of PPO inhibitor resistant weeds. Amaranthus palmeri with the Arg128Met mutation in PPO2 is known (Pest Management Science 73, 1559-1563). Amaranthus palmeri with the Arg128GIy mutation in PPO2 is known (Pest Management Science 73, 1559-1563). Water hemp with the Arg128GIy mutation in PPO2 is known (Pest Management Science, doi: 10.1002/ps.5445). Water hemp having the Arg1281Ile mutation in PPO2 and water hemp having the Arg128Lys mutation in PPO2 are known (Pest Management Science, doi: 10.1002/ps.5445). Solanaceae having a mutation corresponding to Arg128His in PPO2 (solanaceae having an Arg132His mutation in PPO2) is known (WSSA annual meeting, 2018). Amaranthus palmeri with the Gly399Ala mutation in PPO2 is known (Frontiers in Plant Science 10, Article 568). Goosegrass having a mutation corresponding to Ala210Thr in PPO1 (goosegrass having the Ala212Thr mutation in PPO1) is known (WSSA annual meeting, 2019).

Double mutant K127N, 1130V (sometimes also referred to as Lys127Asn, Ile130Val double mutation), found in Amaranthus tuberculatus, and A212T mutation (sometimes also referred to Ala212Thr mutation), so far only found in Eleusine indica, are also known.

Accordingly, preferably PPO resistant weeds are weeds, which contain a AG210, R98L, R128G, R128M, G339A, K127N-1130V, A212T, Arg128His, Arg12811e or Arg128Lys mutation in the Protox enzyme conferring resistance to PPO inhibitors.

The present invention effectively controls, but is not limited to, PPO inhibitor-resistant weeds having these point mutations.

Amaranthus palmeri and Amaranthus tuberculatus populations have evolved as PPO-resistant weeds in many parts of the world. There are three documented mutations in the PPO enzyme which have been identified as conferring resistance to PPO inhibiting herbicides in Amaranthus spp. Firstly, mutations at R128, most commonly to a glycine or methionine, have been documented in both A. palmeri and A. tuberculatus. Secondly, a deletion of amino acid G210 has been found in both key Amaranthus species. Thirdly, mutations at amino acid G399 relating to a change to an alanine has been documented in A. palmeri.

The numbering (e.g., 98, 210 and 399) of the Amaranthus sequence is based on NCBI reference DQ386114. Since the PPO gene is not only variable in length depending on the weed species but also among individual plants from the same species, any mention of amino acids 98, 210 and 399 in the present application includes any equivalent amino acids in case a different reference system is used.

Furthermore, R¹²⁸ is sometimes referred to as R⁹⁸ as the mutation was initially discovered in Ambrosia and the same gene in that species (Ambrosia) lacks a 30 amino acid sequence at the start of the gene. I.e., the R¹²⁸ locus is the same as R⁹⁸; the numbering change is due to the presence of a 30-amino acid signal peptide in A. palmeri. The skilled person is aware of this and would know how to align various PPO sequences in order to determine the mutation position.

In one embodiment, there is provided a method according to the invention wherein PPO resistant weed to be controlled is selected from Acalypha australis (Asian Copperleaf), Amaranthus hybridus (syn: quitensis) (Smooth Pigweed), Amaranthus palmeri (Palmer Amaranth), Amaranthus retroflexus (Redroot Pigweed), Amaranthus tuberculatus (Amaranthus rudis) (Tall/Common Waterhemp), Ambrosia artemisiifolia (Common Ragweed), Avena fatua (Wild Oat), Conyza sumatrensis (Sumatran Fleabane), Descurainia sophia (Flixweed), Eleusine indica (Goosegrass), Euphorbia heterophylla (Wild Poinsettia), Lolium rigidum (Rigid Ryegrass), Poa annua (Annual Bluegrass), and Senecio vernalis (Eastern Groundsel) Preferably, the PPO-resistant weed to be controlled is selected from Amaranthus hybridus (syn: quitensis) (Smooth Pigweed), Amaranthus palmeri (Palmer Amaranth), Amaranthus retroflexus (Redroot Pigweed), and Amaranthus tuberculatus (Amaranthus rudis) (Tall/Common Waterhemp).

More preferably, the PPO-resistant weed to be controlled is Amaranthus palmeri (Palmer Amaranth) or Amaranthus tuberculatus (Amaranthus rudis) (Tall/Common Waterhemp).

In one embodiment, the PPO-resistant weeds have a AG210, G399A, or R¹²⁸ mutation in the protox enzyme conferring resistance to PPO-inhibiting herbicides.

In one embodiment, the PPO-resistant weeds have a glycine amino acid at codon 128 of PPX2L instead of an arginine amino acid, i.e., the PPO-resistant weeds have an R128G mutation in the protox enzyme conferring resistance to PPO-inhibiting herbicides.

In one embodiment, the PPO-resistant weeds have a methionine amino acid at codon 128 of PPX2L instead of an arginine amino acid, i.e., the PPO-resistant weeds have an R128M mutation in the protox enzyme conferring resistance to PPO-inhibiting herbicides.

In one embodiment, the PPO-resistant weeds have a leucine amino acid at codon 128 of PPX2L instead of an arginine amino acid, i.e., the PPO-resistant weeds have an R128L mutation in the protox enzyme conferring resistance to PPO-inhibiting herbicides

In one embodiment, the PPO-resistant weeds have a codon deletion at the position 210 in PPX2L. Preferably, the deleted codon is for glycine amino acid.

In another embodiment, Amaranthus palmeri and/or Amaranthus tuberculatus have a glycine amino acid at codon 128 in the gene coding of the porphyrinogen oxidase enzyme. Preferably, Amaranthus palmeri and/or Amaranthus tuberculatus have a glycine amino acid at codon 128 of PPX2L. More preferably, Amaranthus palmeri and/or Amaranthus tuberculatus have a glycine amino acid at codon 128 of PPX2L instead of an arginine amino acid.

In another embodiment, Amaranthus palmeri and/or Amaranthus tuberculatus have a methionine amino acid at codon 128 in the gene coding of the porphyrinogen oxidase enzyme. Preferably, Amaranthus palmeri and/or Amaranthus tuberculatus have a methionine amino acid at codon 128 of PPX2L. More preferably, Amaranthus palmeri and/or Amaranthus tuberculatus have a methionine amino acid at codon 128 of PPX2L instead of an arginine amino acid.

In another embodiment, the weeds have a codon deletion at the position 210 in the gene coding of the porphyrinogen oxidase enzyme. Preferably, the weeds have a codon deletion at the position 210 of PPX2L.

More preferably, the deleted codon is for a glycine amino acid.

In another embodiment, Amaranthus palmeri and/or Amaranthus tuberculatus have a codon deletion at the position 210 in the gene coding of the porphyrinogen oxidase enzyme. Preferably, Amaranthus palmeri and/or Amaranthus tuberculatus have a codon deletion at the position 210 of PPX2L. More preferably, Amaranthus palmeri and/or Amaranthus tuberculatus have a glycine amino acid deletion.

In another embodiment, the weeds have an alanine amino acid at codon 399 in the gene coding of the porphyrinogen oxidase enzyme. Preferably, the weeds have an alanine amino acid at codon 399 of PPO2.

More preferably, the weeds have an alanine amino acid at codon 399 of PPO2 instead of a glycine amino acid.

In another embodiment, Amaranthus palmeri and/or Amaranthus tuberculatus have an alanine amino acid at codon 399 in the gene coding of the porphyrinogen oxidase enzyme. Preferably, Amaranthus palmeri and/or Amaranthus tuberculatus have an alanine amino acid at codon 399 of PPO2. More preferably, Amaranthus palmeri and/or Amaranthus tuberculatus have an alanine amino acid at codon 399 of PPO2 instead of a glycine amino acid.

The weeds may be selected from the group consisting of Acalypha spp., Amaranthus spp., Ambrosia spp., Avena spp., Conyza spp., Descurainia spp., Euphorbia spp., and Senecio spp. Preferably, the weeds are Amaranthus spp. More preferably, weeds are Amaranthus palmeri and/or Amaranthus tuberculatus.

The weeds of the present application are to be understood as also including those weeds that have been rendered tolerant to herbicides or classes of herbicides (e.g. ALS-, GS-, EPSPS-, PPO-, ACCase- and HPPD-inhibitors) by evolution, by conventional methods of breeding or by genetic engineering. Examples include Amaranthus palmeri that has evolved resistance to glyphosate and/or acetolactate synthase (ALS) inhibiting herbicides.

The present invention still further provides a method of selectively controlling weeds at a locus comprising useful (crop) plants and weeds, wherein the method comprises application to the locus of a weed controlling amount of the compounds of Formula (I) according to the present invention. ‘Controlling’ means killing, reducing or retarding growth or preventing or reducing germination. It is noted that the compounds of Formula (I) show a much improved selectivity compared to know, structurally similar compounds. ‘Locus’ means the area in which the plants are growing or will grow. The application may be applied to the locus pre-emergence and/or postemergence of the crop plant. Some crop plants may be inherently tolerant to herbicidal effects of compounds of Formula (I). Within the scope of present invention, target crops and/or useful plants to be protected typically comprise perennial and annual crops, such as berry plants for example blackberries, blueberries, cranberries, raspberries and strawberries; cereals for example barley, maize (corn), millet, oats, rice, rye, sorghum triticale and wheat; fibre plants for example cotton, flax, hemp, jute and sisal; field crops for example sugar and fodder beet, coffee, hops, mustard, oilseed rape (canola), poppy, sugar cane, sunflower, tea and tobacco; fruit trees for example apple, apricot, avocado, banana, cherry, citrus, nectarine, peach, pear and plum; grasses for example Bermuda grass, bluegrass, bentgrass, centipede grass, fescue, ryegrass, St. Augustine grass and Zoysia grass; herbs such as basil, borage, chives, coriander, lavender, lovage, mint, oregano, parsley, rosemary, sage and thyme; legumes for example beans, lentils, peas and soya beans; nuts for example almond, cashew, ground nut, hazelnut, peanut, pecan, pistachio and walnut; palms for example oil palm; ornamentals for example flowers, shrubs and trees; other trees, for example cacao, coconut, olive and rubber; vegetables for example asparagus, aubergine, broccoli, cabbage, carrot, cucumber, garlic, lettuce, marrow, melon, okra, onion, pepper, potato, pumpkin, rhubarb, spinach and tomato; and vines for example grapes. Preferred crop plants include corn, cereal, soybean, specialty crops, oil palm, and cotton. Specialty crops include fruits and vegetables, tree nuts, dried fruits, and horticulture and nursery crops, including floriculture.

The rates of application of compound of Formula I may vary within wide limits and depend on the nature of the soil, the method of application (pre- or post-emergence; seed dressing; application to the seed furrow; no tillage application etc.), the crop plant, the weed(s) to be controlled, the prevailing climatic conditions, and other factors governed by the method of application, the time of application and the target crop. The compound of Formula I according to the invention is generally applied at a rate of from 10 g/ha to 1000 g/ha, especially from 25 g/ha to 500 g/ha, more especially from 50 g/ha to 250 g/ha, even more especially from 50 g/ha to 200 g/ha. In a particularly preferred embodiment, the compound of Formula (I) according to the invention is generally applied at a rate of from 100 g/ha to 200 g/ha.

The application is generally made by spraying the composition, typically by tractor mounted sprayer for large areas, but other methods such as dusting (for powders), drip or drench can also be used.

The term “useful plants” is to be understood as also including useful plants that have been rendered tolerant to herbicides like bromoxynil or classes of herbicides such as, for example, 4-Hydroxyphenylpyruvate dioxygenase (HPPD) inhibitors, ALS inhibitors, for example primisulfuron, prosulfuron and trifloxysulfuron, 5-enol-pyrovyl-shikimate-3-phosphate-synthase (EPSPS) inhibitors, glutamine synthetase (GS) inhibitors or protoporphyrinogen-oxidase (PPO) inhibitors as a result of conventional methods of breeding or genetic engineering. An example of a crop that has been rendered tolerant to imidazolinones, e.g. imazamox, by conventional methods of breeding (mutagenesis) is Clearfield® summer rape (Canola). Examples of crops that have been rendered tolerant to herbicides or classes of herbicides by genetic engineering methods include glyphosate- and glufosinate-resistant maize varieties commercially available under the trade names RoundupReady®, Herculex I® and LibertyLink®.

The term “useful plants” is to be understood as also including useful plants which have been so transformed by the use of recombinant DNA techniques that they are capable of synthesising one or more selectively acting toxins, such as are known, for example, from toxin-producing bacteria, especially those of the genus Bacillus.

Examples of such plants are: YieldGard® (maize variety that expresses a CryIA(b) toxin); YieldGard Rootworm® (maize variety that expresses a CryIIIB(b1) toxin); YieldGard Plus® (maize variety that expresses a CryIA(b) and a CryIIIB(b1) toxin); Starlink® (maize variety that expresses a Cry9(c) toxin); Herculex I® (maize variety that expresses a CryIF(a2) toxin and the enzyme phosphinothricine N-acetyltransferase (PAT) to achieve tolerance to the herbicide glufosinate ammonium); NuCOTN 33B® (cotton variety that expresses a CryIA(c) toxin); Bollgard I® (cotton variety that expresses a CryIA(c) toxin); Bollgard II® (cotton variety that expresses a CryIA(c) and a CryIIA(b) toxin); VIPCOT® (cotton variety that expresses a VIP toxin); NewLeaf® (potato variety that expresses a CryIIIA toxin); NatureGard® Agrisure® GT Advantage (GA21 glyphosate-tolerant trait), Agrisure® CB Advantage (Bt11 corn borer (CB) trait), Agrisure® RW (corn rootworm trait) and Protecta®.

Compounds of Formula (I) may be used in unmodified form or, preferably, together with the adjuvants conventionally employed in the art of formulation to provide herbicidal compositions. The invention therefore further provides a herbicidal composition, comprising at least one compound Formula (I) and an agriculturally acceptable carrier and optionally an adjuvant. An agricultural acceptable carrier is for example a carrier that is suitable for agricultural use. Agricultural carriers are well known in the art.

To this end the compound of Formula (I) may be conveniently formulated in known manner to emulsifiable concentrates, coatable pastes, directly sprayable or dilutable solutions or suspensions, dilute emulsions, wettable powders, soluble powders, dusts, granulates, and also encapsulations e.g. in polymeric substances. As with the type of the compositions, the methods of application, such as spraying, atomising, dusting, scattering, coating or pouring, are chosen in accordance with the intended objectives and the prevailing circumstances. The compositions may also contain further adjuvants such as stabilizers, antifoams, viscosity regulators, binders or tackifiers as well as fertilizers, micronutrient donors or other formulations for obtaining special effects.

Suitable carriers and adjuvants, e.g. for agricultural use, can be solid or liquid and are substances useful in formulation technology, e.g. natural or regenerated mineral substances, solvents, dispersants, wetting agents, tackifiers, thickeners, binders or fertilizers. Such carriers are for example described in WO 97/33890.

Suspension concentrates are aqueous formulations in which finely divided solid particles of the active compound are suspended. Such formulations include anti-settling agents and dispersing agents and may further include a wetting agent to enhance activity as well an anti-foam and a crystal growth inhibitor. In use, these concentrates are diluted in water and normally applied as a spray to the area to be treated. The amount of active ingredient may range from 0.5% to 95% of the concentrate.

Wettable powders are in the form of finely divided particles which disperse readily in water or other liquid carriers. The particles contain the active ingredient retained in a solid matrix. Typical solid matrices include fuller's earth, kaolin clays, silicas and other readily wet organic or inorganic solids. Wettable powders normally contain from 5% to 95% of the active ingredient plus a small amount of wetting, dispersing or emulsifying agent.

Emulsifiable concentrates are homogeneous liquid compositions dispersible in water or other liquid and may consist entirely of the active compound with a liquid or solid emulsifying agent, or may also contain a liquid carrier, such as xylene, heavy aromatic naphthas, isophorone and other non-volatile organic solvents. In use, these concentrates are dispersed in water or other liquid and normally applied as a spray to the area to be treated. The amount of active ingredient may range from 0.5% to 95% of the concentrate.

Granular formulations include both extrudates and relatively coarse particles and are usually applied without dilution to the area in which treatment is required. Typical carriers for granular Formulations include sand, fuller's earth, attapulgite clay, bentonite clays, montmorillonite clay, vermiculite, perlite, calcium carbonate, brick, pumice, pyrophyllite, kaolin, dolomite, plaster, wood flour, ground corn cobs, ground peanut hulls, sugars, sodium chloride, sodium sulphate, sodium silicate, sodium borate, magnesia, mica, iron oxide, zinc oxide, titanium oxide, antimony oxide, cryolite, gypsum, diatomaceous earth, calcium sulphate and other organic or inorganic materials which absorb or which can be coated with the active compound. Granular Formulations normally contain 5% to 25% of active ingredients which may include surface-active agents such as heavy aromatic naphthas, kerosene and other petroleum fractions, or vegetable oils; and/or stickers such as dextrins, glue or synthetic resins.

Dusts are free-flowing admixtures of the active ingredient with finely divided solids such as talc, clays, flours and other organic and inorganic solids which act as dispersants and carriers.

Microcapsules are typically droplets or granules of the active ingredient enclosed in an inert porous shell which allows escape of the enclosed material to the surroundings at controlled rates. Encapsulated droplets are typically 1 to 50 microns in diameter. The enclosed liquid typically constitutes 50 to 95% of the weight of the capsule and may include solvent in addition to the active compound. Encapsulated granules are generally porous granules with porous membranes sealing the granule pore openings, retaining the active species in liquid form inside the granule pores. Granules typically range from 1 millimetre to 1 centimetre and preferably 1 to 2 millimetres in diameter. Granules are formed by extrusion, agglomeration or prilling, or are naturally occurring. Examples of such materials are vermiculite, sintered clay, kaolin, attapulgite clay, sawdust and granular carbon. Shell or membrane materials include natural and synthetic rubbers, cellulosic materials, styrene-butadiene copolymers, polyacrylonitriles, polyacrylates, polyesters, polyamides, polyureas, polyurethanes and starch xanthates.

Other useful formulations for agrochemical applications include simple solutions of the active ingredient in a solvent in which it is completely soluble at the desired concentration, such as acetone, alkylated naphthalenes, xylene and other organic solvents. Pressurised sprayers, wherein the active ingredient is dispersed in finely-divided form as a result of vaporisation of a low boiling dispersant solvent carrier, may also be used.

Suitable agricultural adjuvants and carriers that are useful in formulating the compositions of the invention in the formulation types described above are well known to those skilled in the art.

Liquid carriers that can be employed include, for example, water, toluene, xylene, petroleum naphtha, crop oil, acetone, methyl ethyl ketone, cyclohexanone, acetic anhydride, acetonitrile, acetophenone, amyl acetate, 2-butanone, chlorobenzene, cyclohexane, cyclohexanol, alkyl acetates, diacetonalcohol, 1,2-dichloropropane, diethanolamine, diethylbenzene, diethylene glycol, diethylene glycol abietate, diethylene glycol butyl ether, diethylene glycol ethyl ether, diethylene glycol methyl ether, N,N-dimethyl formamide, dimethyl sulfoxide, 1,4-dioxane, dipropylene glycol, dipropylene glycol methyl ether, dipropylene glycol dibenzoate, diproxitol, alkyl pyrrolidinone, ethyl acetate, 2-ethyl hexanol, ethylene carbonate, 1,1,1-trichloroethane, 2-heptanone, alpha pinene, d-limonene, ethylene glycol, ethylene glycol butyl ether, ethylene glycol methyl ether, gamma-butyrolactone, glycerol, glycerol diacetate, glycerol monoacetate, glycerol triacetate, hexadecane, hexylene glycol, isoamyl acetate, isobornyl acetate, isooctane, isophorone, isopropyl benzene, isopropyl myristate, lactic acid, laurylamine, mesityl oxide, methoxy-propanol, methyl isoamyl ketone, methyl isobutyl ketone, methyl laurate, methyl octanoate, methyl oleate, methylene chloride, m-xylene, n-hexane, n-octylamine, octadecanoic acid, octyl amine acetate, oleic acid, oleylamine, o-xylene, phenol, polyethylene glycol (PEG400), propionic acid, propylene glycol, propylene glycol monomethyl ether, p-xylene, toluene, triethyl phosphate, triethylene glycol, xylene sulfonic acid, paraffin, mineral oil, trichloroethylene, perchloroethylene, ethyl acetate, amyl acetate, butyl acetate, methanol, ethanol, isopropanol, and higher molecular weight alcohols such as amyl alcohol, tetrahydrofurfuryl alcohol, hexanol, octanol, etc., ethylene glycol, propylene glycol, glycerine and N-methyl-2-pyrrolidinone. Water is generally the carrier of choice for the dilution of concentrates.

Suitable solid carriers include, for example, talc, titanium dioxide, pyrophyllite clay, silica, attapulgite clay, kieselguhr, chalk, diatomaxeous earth, lime, calcium carbonate, bentonite clay, fuller's earth, cotton seed hulls, wheat flour, soybean flour, pumice, wood flour, walnut shell flour and lignin.

A broad range of surface-active agents are advantageously employed in both said liquid and solid compositions, especially those designed to be diluted with carrier before application. These agents, when used, normally comprise from 0.1% to 15% by weight of the formulation. They can be anionic, cationic, non-ionic or polymeric in character and can be employed as emulsifying agents, wetting agents, suspending agents or for other purposes. Typical surface active agents include salts of alkyl sulfates, such as diethanolammonium lauryl sulphate; alkylarylsulfonate salts, such as calcium dodecylbenzenesulfonate; alkylphenol-alkylene oxide addition products, such as nonylphenol-C₁₈ethoxylate; alcohol-alkylene oxide addition products, such as tridecyl alcohol-C₁₆ethoxylate; soaps, such as sodium stearate; alkylnaphthalenesulfonate salts, such as sodium dibutylnaphthalenesulfonate; dialkyl esters of sulfosuccinate salts, such as sodium di(2ethylhexyl) sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; and salts of mono and dialkyl phosphate esters.

Other adjuvants commonly utilized in agricultural compositions include crystallisation inhibitors, viscosity modifiers, suspending agents, spray droplet modifiers, pigments, antioxidants, foaming agents, anti-foaming agents, light-blocking agents, compatibilizing agents, antifoam agents, sequestering agents, neutralising agents and buffers, corrosion inhibitors, dyes, odorants, spreading agents, penetration aids, micronutrients, emollients, lubricants and sticking agents.

The compound of Formula (I) is normally used in the form of agrochemical compositions and can be applied to the crop area or plant to be treated, simultaneously or in succession with further compounds. These further compounds can be e.g. fertilizers or micronutrient donors or other preparations, which influence the growth of plants. They can also be selective herbicides or non-selective herbicides as well as insecticides, fungicides, bactericides, nematicides, molluscicides or mixtures of several of these preparations, if desired together with further carriers, surfactants or application promoting adjuvants customarily employed in the art of formulation. Furthermore, the herbicidal compound of present invention can also be used in mixture with one or more additional herbicides and/or plant growth regulators.

### EXAMPLES

The Examples which follow serve to illustrate the invention.

### Formulation Examples

| Wettable powders | a) | b) | c) |
|---|---|---|---|
| Active ingredient [compound of Formula (I)] | 25% | 50% | 75% |
| sodium lignosulfonate | 5% | 5% | — |
| sodium lauryl sulfate | 3% | — | 5% |
| sodium diisobutylnaphthalenesulfonate | — | 6% | 10% |
| phenol polyethylene glycol ether | — | 2% | — |
| (7-8 mol of ethylene oxide) | | | |
| highly dispersed silicic acid | 5% | 10% | 10% |
| Kaolin | 62% | 27% | — |

The active ingredient is thoroughly mixed with the adjuvants and the mixture is thoroughly ground in a suitable mill, affording wettable powders that can be diluted with water to give suspensions of the desired concentration.

| Powders for dry seed treatment | a) | b) | c) |
|---|---|---|---|
| Active ingredient [compound of Formula (I)] | 25% | 50% | 75% |
| light mineral oil | 5% | 5% | 5% |
| highly dispersed silicic acid | 5% | 5% | — |
| Kaolin | 65% | 40% | — |
| Talcum | — | — | 20% |

The active ingredient is thoroughly mixed with the adjuvants and the mixture is thoroughly ground in a suitable mill, affording powders that can be used directly for seed treatment.

Emulsifiable concentrate

| | |
|---|---|
| active ingredient [compound of Formula (I)] | 10% |
| octylphenol polyethylene glycol ether | 3% |
| (4-5 mol of ethylene oxide) | |
| calcium dodecylbenzenesulfonate | 3% |
| castor oil polyglycol ether (35 mol of ethylene oxide) | 4% |
| Cyclohexanone | 30% |
| xylene mixture | 50% |

Emulsions of any required dilution, which can be used in plant protection, can be obtained from this concentrate by dilution with water.

| Dusts | a) | b) | c) |
|---|---|---|---|
| Active ingredient [compound of Formula (I)] | 5% | 6% | 4% |
| Talcum | 95% | — | — |
| Kaolin | — | 94% | — |
| mineral filler | — | — | 96% |

Ready-for-use dusts are obtained by mixing the active ingredient with the carrier and grinding the mixture in a suitable mill. Such powders can also be used for dry dressings for seed.

Extruder granules

| | |
|---|---|
| Active ingredient [compound of Formula (I)] | 15% |
| sodium lignosulfonate | 2% |
| Carboxymethylcellulose | 1% |
| Kaolin | 82% |

The active ingredient is mixed and ground with the adjuvants, and the mixture is moistened with water. The mixture is extruded and then dried in a stream of air.

Coated granules

| | |
|---|---|
| Active ingredient [compound of Formula (I)] | 8% |
| polyethylene glycol (mol. wt. 200) | 3% |
| Kaolin | 89% |

The finely ground active ingredient is uniformly applied, in a mixer, to the kaolin moistened with polyethylene glycol. Non-dusty coated granules are obtained in this manner.

Suspension concentrate

| | |
|---|---|
| Active ingredient [compound of Formula (I)] | 40% |
| propylene glycol | 10% |
| nonylphenol polyethylene glycol ether (15 mol of ethylene oxide) | 6% |
| Sodium lignosulfonate | 10% |
| Carboxymethylcellulose | 1% |
| Silicone oil (in the form of a 75% emulsion in water) | 1% |
| Water | 32% |

The finely ground active ingredient is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

Flowable concentrate for seed treatment

| | |
|---|---|
| Active ingredient [compound of Formula (I)] | 40% |
| propylene glycol | 5% |
| copolymer butanol PO/EO | 2% |
| tristyrenephenole with 10-20 moles EO | 2% |
| 1,2-benzisothiazolin-3-one (in the form | 0.5% |
| of a 20% solution in water) | |
| monoazo-pigment calcium salt | 5% |
| Silicone oil (in the form of a 75% | 0.2% |
| emulsion in water) | |
| Water | 45.3% |

The finely ground active ingredient is intimately mixed with the adjuvants, giving a suspension concentrate from which suspensions of any desired dilution can be obtained by dilution with water. Using such dilutions, living plants as well as plant propagation material can be treated and protected against infestation by microorganisms, by spraying, pouring or immersion.

### Slow-Release Capsule Suspension

28 parts of a combination of the compound of Formula (I) are mixed with 2 parts of an aromatic solvent and 7 parts of toluene diisocyanate/polymethylene-polyphenylisocyanate-mixture (8:1). This mixture is emulsified in a mixture of 1.2 parts of polyvinylalcohol, 0.05 parts of a defoamer and 51.6 parts of water until the desired particle size is achieved. To this emulsion a mixture of 2.8 parts 1,6-diaminohexane in 5.3 parts of water is added. The mixture is agitated until the polymerization reaction is completed.

The obtained capsule suspension is stabilized by adding 0.25 parts of a thickener and 3 parts of a dispersing agent. The capsule suspension Formulation contains 28% of the active ingredients. The medium capsule diameter is 8-15 microns.

The resulting formulation is applied to seeds as an aqueous suspension in an apparatus suitable for that purpose.

### Biological Examples

### Example 1: Control of Plants with Mutation at Codon 128 with PPO Herbicides Applied Postemergence

The commercial standard PPO inhibitor fomesafen and compound 8 of the present application were applied to three Amaranthus palmeri populations in order to determine the impact of mutations at codon 128 in PPX2L from the wild-type arginine to a glycine or methionine.

The three A. palmeri populations used were as follows: a known PPO inhibitor sensitive population (‘Sensitive’), a population of which each individual was known to be homozygous for a glycine at codon 128 in the protoporphyrinogen oxidase gene PPX2L (‘128G’), and a population of which each individual was known to be homozygous for a methionine at codon 128 in the protoporphyrinogen oxidase gene PPX2L (‘128M’).

Seeds were sown in seed trays containing ericaceous compost and covered with vermiculite. When approximately 1 inch in height plants were transplanted 1 per pot into 3 inch diameter pots containing ericaceous compost. The pots were watered and maintained in a glasshouse providing a 16 H photoperiod of 180 μmol m⁻² s⁻¹ with temperatures of 24° C. day and 18° C. night and 65% relative humidity until 3 inches tall at which point the herbicides were applied at the use rates specified in Table 1 below to 14 individual plants per rate of each of the biotypes.

All treatments were applied as dilutions in reverse osmosis water and with the commercial adjuvant Adigor® at 0.5% by volume. Prior to dilution with water compound 8 was initially dissolved to a 5% solution in a solvent mixture comprising 11.12% Emulsogen EL 360, 44.44% Dowanol DPM and 44.44% N-methyl pyrrolidone. Herbicide applications were carried out in a track sprayer with a flat fan nozzle applying the herbicide treatments at a rate of 200 L/ha⁻¹.

After treatment, the plants were watered and maintained in a glasshouse providing a 16 H photoperiod of 180 μmol m⁻² s⁻¹ with temperatures of 24° C. day and 18° C. night and 65% relative humidity until 14 days after application at which point they were assessed on a ‘dead or alive’ basis. The plants still alive at this point were classed as surviving the herbicide application and the averaged results of this assessment are presented in Table 1.

TABLE 1

| | | | Average % Survival of 14 repetitions | | |
|---|---|---|---|---|---|
| Treatment | Herbicide | Rate (g ai/ha⁻¹) | Sensitive | R128G | R128M |
| 1 | Fomesafen | 0.25 | 100 | 100 | 100 |
| 2 | Fomesafen | 0.5 | 100 | 100 | 100 |
| 3 | Fomesafen | 1 | 93 | 100 | 100 |
| 4 | Fomesafen | 2 | 71 | 100 | 100 |
| 5 | Fomesafen | 4 | 14 | 100 | 100 |
| 6 | Fomesafen | 8 | 0 | 100 | 100 |
| 7 | Fomesafen | 16 | 0 | 100 | 93 |
| 8 | Fomesafen | 32 | 0 | 93 | 43 |
| 9 | Fomesafen | 64 | 0 | 36 | 21 |
| 10 | Fomesafen | 128 | 0 | 36 | 0 |
| 11 | Compound 8 | 0.25 | 100 | 100 | 100 |
| 12 | Compound 8 | 0.5 | 100 | 100 | 100 |
| 13 | Compound 8 | 1 | 50 | 100 | 100 |
| 14 | Compound 8 | 2 | 43 | 100 | 100 |
| 15 | Compound 8 | 4 | 14 | 93 | 79 |
| 16 | Compound 8 | 8 | 0 | 50 | 57 |
| 17 | Compound 8 | 16 | 0 | 0 | 0 |
| 18 | Compound 8 | 32 | 0 | 0 | 0 |
| 19 | Compound 8 | 64 | 0 | 0 | 0 |
| 20 | Compound 8 | 128 | 0 | 0 | 0 |

### Conclusion

Compound 8 demonstrated a similar ability to fomesafen in controlling the ‘Sensitive’ population, with both herbicides achieving complete control (i.e. no surviving plants) of this population at the 8 g ai/ha⁻¹ use rate. However, surprisingly compound 8 demonstrated the ability to achieve complete control of both ‘128G’ and ‘128M’ at the 16 g ai/ha⁻¹ rate, whereas fomesafen was only able to achieve complete control of ‘128M’ at the 128 g ai/ha⁻¹ rate and was able to kill only 5/14 individuals of ‘128G’ at 128 g ai/ha⁻¹

### Example 2: Control of Plants with Mutation at Codon 210 with PPO Herbicides Applied Postemergence

The commercial standard PPO inhibitor fomesafen and compound 8 of the present application were applied to a PPO inhibitor herbicide resistant Amaranthus tuberculatus population. In particular, each individual plant in the A. tuberculatus population was known to be homozygous for the deletion of the glycine residue at codon 210 in the protoporphyrinogen oxidase gene PPX2L.

Seeds were sown in seed trays containing ericaceous compost and covered with vermiculite. When approximately 1 inch in height plants were transplanted 1 per pot into 3 inch diameter pots containing ericaceous compost. The pots were watered and maintained in a glasshouse providing a 16 H photoperiod of 180 μmol m⁻² s⁻¹ with temperatures of 24° C. day and 18° C. night and 65% relative humidity until 3 inches tall at which point the herbicides were applied at the use rates specified in Table 2 below to 16 individual plants per rate.

All treatments were applied as dilutions in reverse osmosis water and with the commercial adjuvant Agridex® at 1% by volume. Prior to dilution with water, compound 8 was initially dissolved to a 5% solution in a solvent mixture comprising 11.12% Emulsogen EL 360, 44.44% Dowanol DPM and 44.44% N-methyl pyrrolidone. Herbicide applications were carried out in a track sprayer with a flat fan nozzle applying the herbicide treatments at a rate of 200 L/ha⁻¹.

Aftertreatment, the plants were watered and maintained in a glasshouse providing a 16 H photoperiod of 180 μmol m⁻² s⁻¹ with temperatures of 2400 day and 1800 night and 65% relative humidity until 14 days after application at which point they were assessed on a ‘dead or alive’ basis. The plants still alive at this point were classed as surviving the herbicide application and the averaged results of this assessment are presented in Table 2.

TABLE 2

| | | | Average % Survival |
|---|---|---|---|
| Treatment | Herbicide | Rate (g ai/ha⁻¹) | of 16 repetitions |
| 1 | Fomesafen | 0.82 | 100 |
| 2 | Fomesafen | 1.64 | 100 |
| 3 | Fomesafen | 3.28 | 100 |
| 4 | Fomesafen | 6.56 | 100 |
| 5 | Fomesafen | 13.13 | 100 |
| 6 | Fomesafen | 26.25 | 100 |
| 7 | Fomesafen | 52.5 | 81.3 |
| 8 | Fomesafen | 105 | 62.5 |
| 9 | Fomesafen | 210 | 0 |
| 10 | Fomesafen | 420 | 0 |
| 11 | Fomesafen | 840 | 0 |
| 12 | Compound 8 | 2 | 100 |
| 13 | Compound 8 | 4 | 100 |
| 14 | Compound 8 | 8 | 75 |
| 15 | Compound 8 | 16 | 12.5 |
| 16 | Compound 8 | 32 | 12.5 |
| 17 | Compound 8 | 64 | 0 |
| 18 | Compound 8 | 128 | 0 |
| 19 | Compound 8 | 256 | 0 |

### Conclusion

Surprisingly, Compound 8 demonstrated superior control of PPO inhibitor herbicide resistant Amaranthus tuberculatus with a mutation at codon 210 compared to fomesafen, especially at use rates of at least 8-105 g/ha. In particular, no plants survived application of compound 8 at or beyond 64 g ai/ha⁻¹ This is in comparison to fomesafen where no plants survived application at or beyond 210 g ai/ha⁻¹.

### Example 3: Control of Plants with Mutation at Codon 210 with PPO Herbicides in Field Trial

A field trial was carried out in a plot in Illinois USA populated with A. tuberculatus, about 60-70% of which contain the ΔG210 mutation.

The trial was laid out as a randomized complete block design with two replicates per treatment. The plot size per replicate was set to 10 m². Compound 8 and commercial standard PPO herbicides (saflufenacil, fomesafen, glyphosate, glufosinate, and tiafenacil) were applied to about 4 inch (about 10 cm) tall A. tuberculatus using a water volume of 300 I/ha. The efficacy of the tested compounds was visually assessed 14 days after the application and expressed in % weed control, whereas ratings range from 100% being complete control and 0% representing weed populations/growth similar to what is observed in the untreated check. Only species present at a sufficient density and consistency were assessed for reliable ratings. Results are presented in Table 3.

TABLE 3
Control of A. tuberculatus visually assessed
as % weed control 14 days after application.

| | | Use rate | |
|---|---|---|---|
| Treatment | Herbicide compound | (g ai/ha) | Control (%) |
| 1 | Compound 8 | 50 | 80 |
| 2 | Compound 8 | 100 | 92.5 |
| 3 | Compound 8 | 150 | 99 |
| 4 | Compound 8 | 200 | 94.5 |
| 5 | Saflufenacil | 50 | 55 |
| 6 | Saflufenacil | 100 | 50 |
| 7 | Fomesafen | 280 | 25 |
| 8 | Glyphosate | 1540 | 10 |
| 9 | Glufosinate | 655 | 70 |
| 10 | Tiafenacil | 50 | 33 |
| 11 | Tiafenacil | 100 | 30 |
| 12 | Tiafenacil | 150 | 33 |

### Conclusion

Example 3 demonstrates that compound 8 provides excellent weed control of PPO inhibitor herbicide resistant A. tuberculatus at all tested rates of 50 to 200 g AI/ha. Efficacy is especially strong (>90%) at use rates of 100 to 200 g AI/ha. Surprisingly, compound 8 clearly outperforms all the standard commercial products, including saflufenacil, fomesafen, glyphosate, glufosinate, and tiafenacil at all tested rates between 50 and 200 g AI/ha.

1. A method for controlling the growth of protoporphyrinogen IX oxidase (PPO) inhibitor herbicide resistant weeds, which comprises applying to the weed, part of the weed, weed propagation material, or the locus of the weed, an effective amount of a compound of Formula (I): 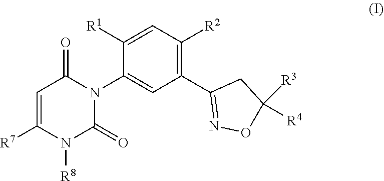
wherein
each R¹ and R² is selected from the group consisting of hydrogen and halogen;
R³ is selected from the group consisting of hydrogen, C₁-C₄alkyl, CO₂R⁵ and CH₂OR⁶;
R⁴ is selected from the group consisting of hydrogen and C₁-C₄alkyl;
R⁵ is selected from the group consisting of hydrogen, C₁-C₄alkyl, C₁-C₄haloalkyl, C₃-C₆alkenyl, C₃-C₆alkynyl, C₁-C₄alkoxyC₁-C₄alkyl, C₁₋₄alkylcarbonylC₁₋₄alkyl and heterocyclylC₁-C₃alkyl;
R⁶ is selected from the group consisting of C₁-C₂alkylsulfonyl, C₁-C₄alkylcarbonyl and C₃-C₄cycloalkylcarbonyl;
R⁷ is selected from the group consisting of hydrogen, C₁-C₄alkyl and C₁-C₄haloaklyl;
R⁸ is selected from the group consisting of hydrogen, amino, C₁-C₆alkyl, C₃-C₆alkenyl and C₃-C₆alkynyl; and
wherein the PPO-resistant weeds are weeds that are resistant to at least one PPO-inhibiting herbicide, except the compounds of Formula (I).

2. The method according to claim 1, wherein the PPO-resistant weeds have a mutation at amino acid 128 and/or amino acid 210 in the gene coding for the protoporphyrinogen oxidase enzyme.

3. The method according to claim 1, wherein the PPO-resistant weeds have a glycine amino acid at codon 128 in the gene coding for the protoporphyrinogen oxidase enzyme.

4. The method according to claim 1, wherein the PPO-resistant weeds have a methionine amino acid at codon 128 in the gene coding for the protoporphyrinogen oxidase enzyme.

5. The method according to claim 1, wherein the PPO-resistant weeds have a codon deletion at position 210 in the gene coding for the protoporphyrinogen oxidase enzyme.

6. The method according to claim 5, wherein the deleted codon is for glycine amino acid.

7. The method according to claim 1, wherein the PPO-resistant weeds are selected from the group consisting of Acalypha spp., Amaranthus spp., Ambrosia spp., Avena spp., Conyza spp., Descurainia spp., Euphorbia spp., and Senecio spp.

8. The method according to claim 1, wherein the PPO-resistant weeds are Amaranthus spp.

9. The method according to claim 1, wherein the PPO-resistant weeds are selected from the group consisting of Amaranthus palmeri and Amaranthus tuberculatus.

10. The method according to claim 1, wherein the compound of Formula (I) is applied as part of an agrochemical composition comprising at least one further compound: herbicide B.

11. The method according to claim 10, wherein herbicide B is selected from the group consisting of S-metolachlor, glufosinate, L-glufosinate, glyphosate, mesotrione, bicyclopyrone, and metribuzin.

12. The method according to claim 1, wherein the compound of Formula (I) is applied as part of an agrochemical composition further comprising an agrochemically-acceptable diluent or carrier.

13. The method according to claim 1, wherein the compound of Formula (I) is applied in an amount from 50 g/ha to 200 g/ha.

14. The use of a compound of Formula (I) as defined in claim 1 for controlling the growth of protoporphyrinogen IX oxidase (PPO) inhibitor herbicide resistant weeds.

15. The use according to claim 14, wherein the protoporphyrinogen IX oxidase (PPO) inhibitor herbicide resistant weeds have a mutation at amino acid 128 and/or amino acid 210 in the gene coding for the protoporphyrinogen oxidase enzyme.

16. The use of the composition as defined in claim 10 for controlling the growth of protoporphyrinogen IX oxidase (PPO) inhibitor herbicide resistant weeds.

17. The use according to claim 16, wherein the protoporphyrinogen IX oxidase (PPO) inhibitor herbicide resistant weeds have a mutation at amino acid 128 and/or amino acid 210 in the gene coding for the protoporphyrinogen oxidase enzyme.
